(19) United States
(12) Patent Application Publication
(10) Pub. No.: US 2025/0142362 A1
(43) Pub. Date: May 1, 2025

(54) METHOD FOR UPDATING ARTIFICIAL INTELLIGENCE SESSION, COMMUNICATION APPARATUS, AND STORAGE MEDIUM

(71) Applicant: Beijing Xiaomi Mobile Software Co., Ltd., Beijing (CN)

(72) Inventors: Dong CHEN, Beijing (CN); Zhibin HE, Beijing (CN)

(73) Assignee: Beijing Xiaomi Mobile Software Co., Ltd., Beijing (CN)

(21) Appl. No.: 18/835,748

(22) PCT Filed: Feb. 7, 2022
(86) PCT No.: PCT/CN2022/075424

§ 371 Date: Aug. 5, 2024

(51) Int. Cl. H04W 24/02; H04W 76/20; H04W 80/10

(52) U.S. Cl. CPC H04W 24/02; H04W 76/20; H04W 80/10

(57) ABSTRACT

Methods for updating an artificial intelligence (AI) session, communication apparatuses, and storage mediums are provided, which can be applied to the technical field of communications. The method executed by a terminal device comprises: sending an AI session update request to an access network (RAN) device; and then receiving a session management (SM) context modification result of an AI session returned by the RAN device.

### CROSS-REFERENCE TO RELATED APPLICATIONS

The present disclosure is a U.S. national phase of PCT Application No. PCT/CN2022/075424 filed on Feb. 7, 2022, the content of which is hereby incorporated by reference in its entirety.

### TECHNICAL FIELD

The present disclosure relates to a field of communication technology, and in particular to methods for updating an artificial intelligence session, communication apparatuses, and storage mediums.

### BACKGROUND

With the continuous development of artificial intelligence (AI) technologies, the AI technologies are increasingly applied in a communication field.

In related technologies, a network AI application is deployed as an independent network function (NF) on an AI network device in a core network architecture. When a terminal device uses an AI service, the terminal device may need to invoke the corresponding AI service as required.

### SUMMARY

Embodiments of the present disclosure provide methods for updating an artificial intelligence session, communication apparatuses, and storage mediums.

According to a first aspect, an embodiment of the present disclosure provides a method for updating an artificial intelligence session. The method is executed by a terminal device and includes: sending an artificial intelligence (AI) session update request to a radio access network (RAN) device; and receiving a session management (SM) context modification result of an AI session returned by the RAN device.

According to a second aspect, an embodiment of the present disclosure provides another method for updating an artificial intelligence session. The method is executed by a radio access network (RAN) device and includes: receiving an artificial intelligence (AI) session update request sent by a terminal device; sending the AI session update request to an access and mobility management function (AMF) device; receiving a session management (SM) context modification result of an AI session sent by the AMF device; and transparently transmitting the SM context modification result of the AI session to the terminal device.

According to a third aspect, an embodiment of the present disclosure provides another method for updating an artificial intelligence session. The method is executed by an access and mobility management function (AMF) device and includes: receiving an artificial intelligence (AI) session update request sent by a radio access network (RAN) device, where the update request includes an identifier (ID) of a to-be-updated AI session; sending the AI session update request to a session management function (SMF) device, where the update request includes the ID; receiving a session management (SM) context modification result of the AI session returned by the SMF device; and sending the SM context modification result of the AI session to the RAN device.

According to a fourth aspect, an embodiment of the present disclosure provides a communication apparatus. The communication apparatus includes a processor and a memory, the memory stores a computer program, and the processor executes the computer program stored in the memory, so that the communication apparatus executes the method according to the first aspect, the method according to the second aspect, or the method according to the third aspect.

According to a fifth aspect, an embodiment of the present disclosure provides a computer-readable storage medium, configured to store instructions used by the terminal device. When the instruction is executed, the terminal device executes the method according to the first aspect, the method according to the second aspect, or the method according to the third aspect.

### BRIEF DESCRIPTION OF DRAWINGS

In order to more clearly illustrate technical solutions in the embodiments of the present disclosure or in the background, the accompanying drawings that need to be used in the embodiments of the present disclosure or the background will be described below.

FIG. 1 is a schematic architectural diagram of a communication system provided by an embodiment of the present disclosure.

FIG. 2 is a schematic flowchart of a method for updating an artificial intelligence session provided by an embodiment of the present disclosure.

FIG. 3 is a schematic flowchart of another method for updating an artificial intelligence session provided by an embodiment of the present disclosure.

FIG. 4 is a schematic flowchart of still another method for updating an artificial intelligence session provided by an embodiment of the present disclosure.

FIG. 5 is a schematic flowchart of still another method for updating an artificial intelligence session provided by an embodiment of the present disclosure.

FIG. 6 is a schematic flowchart of still another method for updating an artificial intelligence session provided by an embodiment of the present disclosure.

FIG. 7 is a schematic flowchart of still another method for updating an artificial intelligence session provided by an embodiment of the present disclosure.

FIG. 8 is a schematic flowchart of still another method for updating an artificial intelligence session provided by an embodiment of the present disclosure.

FIG. 9 is a schematic flowchart of still another method for updating an artificial intelligence session provided by an embodiment of the present disclosure.

FIG. 10 is a schematic flowchart of still another method for updating an artificial intelligence session provided by an embodiment of the present disclosure.

FIG. 11 is a schematic flowchart of still another method for updating an artificial intelligence session provided by an embodiment of the present disclosure.

FIG. 12 is a schematic flowchart of still another method for updating an artificial intelligence session provided by an embodiment of the present disclosure.

FIG. 13 is a schematic flowchart of still another method for updating an artificial intelligence session provided by an embodiment of the present disclosure.

FIG. 14 is a schematic flowchart of still another method for updating an artificial intelligence session provided by an embodiment of the present disclosure.

FIG. 15 is a schematic interaction diagram of still another method for updating an artificial intelligence session provided by an embodiment of the present disclosure.

FIG. 16 is a schematic structural diagram of a communication apparatus provided by an embodiment of the present disclosure.

FIG. 17 is a schematic structural diagram of another communication apparatus provided by an embodiment of the present disclosure.

FIG. 18 is a schematic structural diagram of a chip provided by an embodiment of the present disclosure.

### DETAILED DESCRIPTION

Exemplary embodiments will be described in detail herein, with examples thereof represented in the accompanying drawings. When the following description involves the accompanying drawings, same numerals in different figures represent same or similar elements unless otherwise indicated. Implementations described in the following exemplary embodiments do not represent all implementations consistent with the present disclosure. On the contrary, they are merely examples of apparatuses and methods consistent with some aspects of the present disclosure as detailed in the appended claims.

For ease of understanding, terms involved in the present disclosure are first described.

### 1. Access and Mobility Management Function (AMF)

The AMF is a core network control plane access point for terminals and wireless devices, which receives all connection and session related information from user equipment, and execute a registration, connection, reachability, and mobility management. In addition, the AMF provides a session management message transmission channel for terminal devices and session management function (SMF) devices, to provide an attestation function and an authentication function during user access.

### 2. Session Management Function (SMF)

The SMF is responsible for tunnel maintenance, internet protocol (IP) address allocation and management, control in policy enforcement and quality of service (QoS), charging data collection, roaming, and the like.

### 3. Radio Access Network (RAN)

The RAN is an implementation of a radio access technology. The RAN exists between a device (for example, a mobile phone, a computer, or any remotely controlled machine) and a core network (CN), and provides a communication connection therebetween.

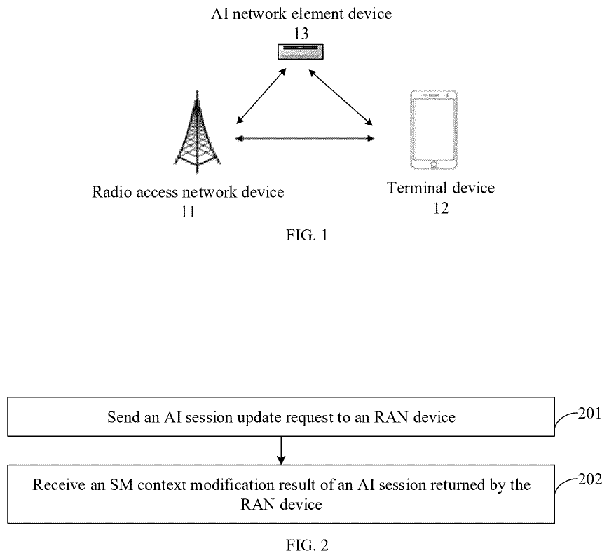

Referring to FIG. 1, FIG. 1 is a schematic architectural diagram of a communication system provided by an embodiment of the present disclosure. The communication system may include, but is not limited to, one network device and one terminal device. The number of devices and forms of devices shown in FIG. 1 are only exemplary and does not constitute limitations to the embodiments of the present disclosure. In a practical application, the communication system may include two or more network devices and two or more terminal devices. The communication system shown in FIG. 1 may include one radio access network device 11, one terminal device 12, and one AI network element device 13.

It should be noted that technical solutions of the embodiments of the present disclosure may be applied to various types of communication systems. For example, a long term evolution (LTE) system, a 5th generation (5G) mobile communication system, a 5G new radio (NR) system, or other future new mobile communication systems, etc.

The radio access network device 11 in the embodiments of the present disclosure is an entity for sending or receiving a signal on a network side. For example, the radio access network device 11 may be an evolved NodeB (eNB), a transmission reception point (TRP), a next generation NodeB (gNB) in an NR system, a base station in other future mobile communication systems, or an access node in a wireless fidelity (WiFi) system, etc. Specific technologies and specific device forms used by the network device are not limited in the embodiments of the present disclosure. The network device provided in the embodiments of the present disclosure may be composed of a central unit (CU) and a distributed unit (DU). The CU may also be referred to as a control unit. A protocol layer of the network device, for example a base station, may be split by using a structure of a CU-DU. Functions of a part of the protocol layer are centrally controlled by the CU, and functions of the remaining part or all of the protocol layer are distributed in the DU, such that the CU centrally controls the DU.

The terminal device 12 in the embodiments of the present disclosure is an entity for receiving or sending a signal on a user side, for example a mobile phone. The terminal device may also be referred to as a terminal, user equipment (UE), a mobile station (MS), a mobile terminal (MT), etc. The terminal device may be a car with a communication function, a smart car, a mobile phone, a wearable device, a Pad, a computer with a wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home, etc. The embodiments of the present disclosure do not limit specific technologies and specific device forms adopted by the terminal device.

It may be understood that the communication system described in the embodiments of the present disclosure is used to describe the technical solutions in the embodiments of the present disclosure more clearly, and does not constitute a limitation on the technical solutions provided in the embodiments of the present disclosure. Those skilled in the art may know that with evolution of system architectures and emergence of new business scenarios, the technical solutions provided in the embodiments of the present disclosure are also applicable to similar technical problems.

In the present disclosure, when requesting an AI service, a terminal device needs to first establish a session with an AI network element device, then may update the AI session as required, and then invoke the AI service. In a process of establishing the session between the terminal device and the AI network element device, an associated session management context and resource configuration data may be generated, to ensure secure, fast, and effective communication. Therefore, when updating the AI session, the terminal device needs to modify one or more AI service parameters, attribute information of the AI session, the session management context, and the resource configuration, to provide a condition for effectively invoking the AI service. Methods and apparatuses for updating an artificial intelligence session provided by the present disclosure will be described in detail below with reference to the accompanying drawings.

Referring to FIG. 2, FIG. 2 is a schematic flowchart of a method for updating an artificial intelligence session provided by an embodiment of the present disclosure. The method is executed by a terminal device. As shown in FIG. 2, the method may include but is not limited to the following steps 201-202.

At step 201, an artificial intelligence (AI) session update request is sent to a radio access network (RAN) device.

The AI session update request may include an identifier (ID), a request type, AI attribute information, etc., which is not limited in the present disclosure.

In the present disclosure, the ID may be any information that may uniquely identify the AI session. For example, the ID may be an AI session serial number generated by the terminal device based on a type or an identifier of a to-be-updated AI service and an identifier of the terminal device, etc., which is not limited in the present disclosure.

The AI attribute information may include information, such as a name, a priority, a feature word, etc., of the requested AI service, that may uniquely identify an AI service, which is not limited in the present disclosure.

The request type may be any type of operations to the session, for example, modifying the session, creating the session, deleting the session, etc. It may be understood that the request type in the AI session update request is the modifying session.

In the present disclosure, when the terminal device is to update one or more parameters of any AI service, the terminal device may randomly generate an ID of the AI session, and establish a connection with the requested AI service; and then the terminal device may generate an AI session update request based on the ID, the request type, and the AI attribute information of the requested AI service, and send the request to the RAN device to update the AI session.

At step 202, a session management (SM) context modification result of an AI session returned by the RAN device is received.

The session management context modification result may include information, such as the ID of AI session, the AI attribute information, a state of the session management context modification result, etc., which is not limited in the present disclosure.

In the present disclosure, after the terminal device requests to update the AI session, and after the RAN device receives the SM context modification result returned by the AMF device, the RAN device may return the SM context modification result to the terminal device. Therefore, the terminal device may determine, by parsing the SM context modification result, whether the AI session update succeeds.

In the present disclosure, the terminal device may send the artificial intelligence (AI) session update request to the radio access network (RAN) device, and then may receive the session management (SM) context modification result of the AI session returned by the RAN device. Therefore, the AI session is updated through an AI session update process closely coupled with a network process, so that the communication system may provide the AI service systematically and reliably.

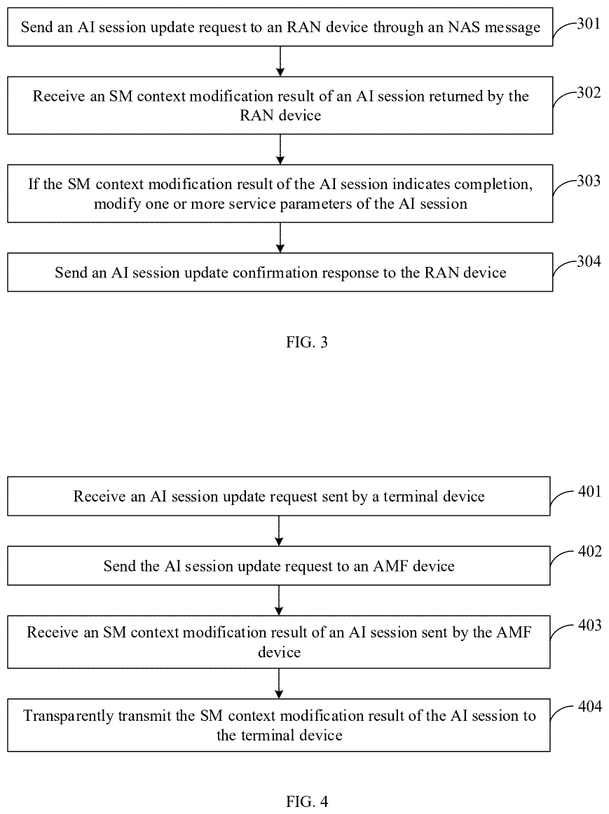

Referring to FIG. 3, FIG. 3 is a schematic flowchart of a method for updating an artificial intelligence session provided by an embodiment of the present disclosure. The method is executed by a terminal device. As shown in FIG. 3, the method may include but is not limited to the following steps 301-304.

At step 301, the AI session update request is sent to the RAN device through a non-access stratum (NAS) message.

The AI session update request may include an identifier (ID), a request type, AI attribute information, etc., which is not limited in the present disclosure.

In the present disclosure, the ID may be any information that may uniquely identify the AI session. For example, the ID may be an AI session serial number generated by the terminal device based on a type or an identifier of a to-be-updated AI service and an identifier of the terminal device, etc., which is not limited in the present disclosure.

The AI attribute information may include information, such as a name, a priority, a feature word, etc., of the requested AI service, that may uniquely identify an AI service, which is not limited in the present disclosure.

The request type may be any type of operations to the session, for example, modifying the session, creating the session, deleting the session, etc. It may be understood that the request type in the AI session update request is the modifying session.

In the present disclosure, the terminal device may configure the AI session update request in the NAS message so that after the RAN device receives the NAS message, the RAN device may determine information on the AI session update request by parsing the NAS message.

At step 302, a session management (SM) context modification result of an AI session returned by the RAN device is received.

In the present disclosure, a specific implementation process of the step 302 may refer to detailed description of any embodiment of the present disclosure, which is not repeated herein.

At step 303, in a case where the SM context modification result of the AI session indicates completion, one or more service parameters of the AI session are modified.

In the present disclosure, after the terminal device receives the SM context modification result returned by the RAN device, the terminal device may determine the state of the SM context modification result. In a case where the SM context modification result of the AI session is in a success state, the terminal device may determine that the SM context modification has been completed, that is, a related device has completed the preparation for invoking an AI application, and then the terminal device may modify the one or more service parameters of the AI session as required, to invoke the AI service.

Optionally, the terminal device may modify parameters, such as quality of AI service (QoAIS), AI data flow, etc., of the AI session.

At step 304, an update confirmation response for the AI session is sent to the RAN device.

In the present disclosure, after the terminal device completes modification of related parameters of the AI session, the terminal device may send the update confirmation response for the AI session to the RAN device. Therefore, the RAN device may determine, according to the update confirmation response for the AI session, that the terminal device has completed AI session invoking preparation, and then may instruct the AI network element device to configure the corresponding AI session to be available (in an available state), so that the terminal device invokes the AI service, thereby improving reliability of a communication connection.

In the present disclosure, after the terminal device sends the AI session update request to the RAN device through the NAS message, the terminal device may receive the SM context modification result of the AI session returned by the RAN device, modify the service parameters of the AI session in the case where the SM context modification result of the AI session indicates completion, and send the update confirmation response for the AI session to the RAN device. Therefore, the AI session is updated and interacted through an AI session update process closely coupled with a network process, so that the communication system may provide the AI service systematically and reliably.

Referring to FIG. 4, FIG. 4 is a schematic flowchart of a method for updating an artificial intelligence session provided by an embodiment of the present disclosure. The method is executed by an RAN device. As shown in FIG. 4, the method may include but is not limited to the following steps 401-404.

At step 401, an AI session update request sent by a terminal device is received.

The AI session update request may include an ID, a request type, AI attribute information, etc., which is not limited in the present disclosure.

In the present disclosure, the ID may be any information that may uniquely identify the AI session. For example, the ID may be an AI session serial number generated by the terminal device based on a type or an identifier of a to-be-invoked AI service and an identifier of the terminal device, etc., which is not limited in the present disclosure.

The AI attribute information may include information, such as a name, a priority, a feature word, etc., of the requested AI service, that may uniquely identify an AI service, which is not limited in the present disclosure.

The request type may be any type of operations to the session, for example, modifying the session, creating the session, deleting the session, etc. It may be understood that the request type in the AI session update request is the modifying session.

In the present disclosure, when the terminal device is to update one or more parameters of any AI service, the terminal device may randomly generate an ID of AI session, and establish a connection with the requested AI service; and then the terminal device may generate an AI session update request based on the ID, the request type, and the AI attribute information of the requested AI service, and send the request to the RAN device to update the AI session.

At step 402, the AI session update request is sent to an access and mobility management function (AMF) device.

In the present disclosure, after the RAN device receives the AI session update request, the RAN device may send the AI session update request to the AMF device, so that the AMF device may determine that the terminal device has initiated the AI session update request.

At step 403, a session management (SM) context modification result of an AI session sent by the AMF device is received.

The session management context modification result may include information, such as the ID, the AI attribute information, a state of the session management context modification result, etc., which is not limited in the present disclosure.

In the present disclosure, when the terminal device requests to modify the AI session update, a session management function (SMF) device may update the session context of the AI session according to the information of the AI session update request, and return a modification result to the terminal device through the AMF device and the RAN device.

In the present disclosure, after the AMF device receives the SM context modification result fed back by the SMF device, the AMF device may send the SM context modification result to the RAN device. Therefore, the RAN device may determine, by parsing the SM context modification result, whether the AI session context update succeeds.

At step 404, the SM context modification result of the AI session is transparently transmitted to the terminal device.

In the present disclosure, after the terminal device requests to update the AI session, and after the RAN device receives the SM context modification result returned by the AMF device, the RAN device may return the SM context modification result to the terminal device. Therefore, the terminal device may determine, by parsing the SM context modification result, whether the AI session update succeeds.

In the present disclosure, after the RAN device receives the AI session update request sent by the terminal device, the RAN device may send the AI session update request to the AMF device, and then after the RAN device receives the SM context modification result of the AI session sent by the AMF device, the RAN device may transparently transmit the SM context modification result of the AI session to the terminal device. Therefore, the AI session is updated through an AI session update process closely coupled with a network process, so that the communication system may provide the AI service systematically and reliably.

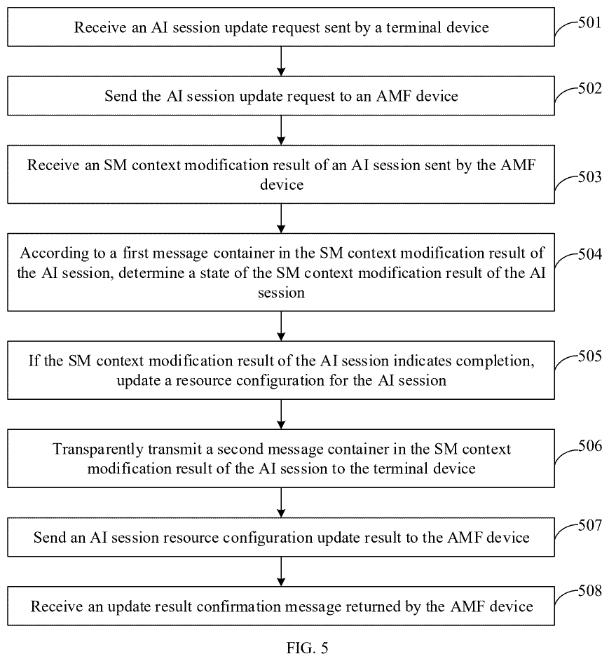

Referring to FIG. 5, FIG. 5 is a schematic flowchart of a method for updating an artificial intelligence session provided by an embodiment of the present disclosure. The method is executed by a radio access network (RAN) device. As shown in FIG. 5, the method may include but is not limited to the following steps 501-508.

At step 501, an artificial intelligence (AI) session update request sent by a terminal device is received.

At step 502, the AI session update request is sent to an access and mobility management function (AMF) device.

At step 503, a session management (SM) context modification result of an AI session sent by the AMF device is received.

In the present disclosure, the specific implementation processes of the steps 501-503 may refer to detailed description of any embodiment of the present disclosure, which is not repeated herein.

At step 504, according to a first message container in the SM context modification result of the AI session, a state of the SM context modification result of the AI session is determined.

In the present disclosure, the SM context modification result of the AI session sent by the AMF device may include two message containers, where a message container for instructing the SM context modification result to the RAN device may be a first message container for carrying a message transmitted by an N2 interface. The N2 interface may be an interface for interacting messages between the RAN device and the AMF device.

In addition, the N2 message may include an ID of AI session, AI attribute information, a state of a corresponding SM context modification result, etc., which is not limited in the present disclosure.

In the present disclosure, the RAN device may determine the state of the SM context modification result and the AI attribute information of the AI session, by parsing the N2 message in the first message container in the SM context modification result.

At step 505, in a case where the SM context modification result of the AI session indicates completion, a resource configuration for the AI session is updated.

The resource configuration may be the quality of artificial intelligence (AI) service (QoAIS), the AI data flow, etc., which is not limited in the present disclosure.

In the present disclosure, when the RAN determines that the SM context modification result of the AI session is in the success state, the RAN may update the resource configuration for the AI session according to the AI attribute information in the N2 message, and generate the resource configuration update result of the AI session, to indicate whether update of the resource configuration for the AI session succeeds.

At step 506, a second message container in the SM context modification result of the AI session is transparently transmitted to the terminal device.

In the present disclosure, the SM context modification result of the AI session sent by the AMF device may include two message containers, where a message container for instructing the SM context modification result to the terminal device may be a second message container for carrying a message transmitted by an N1 interface. The N1 interface may be an interface for interacting messages between the RAN device and the terminal device.

In addition, the N1 message may include an ID of AI session, AI attribute information, a state of a corresponding SM context modification result, etc., which is not limited in the present disclosure.

At step 507, a resource configuration update result of the AI session is sent to the AMF device.

In the present disclosure, after the RAN device completes the update of the resource configuration, the RAN device may send the resource configuration result to the AMF device, to indicate that the RAN device has completed the update of the resource configuration.

At step 508, an update result confirmation message returned by the AMF device is received.

In the present disclosure, after the AMF device receives the resource configuration update result of the AI session sent by the RAN device, the AMF device may return the update result confirmation message to the RAN device, to indicate that the AMF device has received the resource configuration update result of the AI session. Therefore, confirmation and interaction of the resource configuration related information between the AMF device and the RAN device are completed through the AI session update process closely coupled with the network process.

In the present disclosure, after the RAN device receives the AI session update request sent by the terminal device, the RAN device may send the AI session update request to the AMF device; then after the RAN device receives the SM context modification result of the AI session sent by the AMF device, the RAN device may determine the state of the SM context modification result of the AI session according to the first message container in the SM context modification result of the AI session, update the resource configuration for the AI session in the case where the SM context modification result of the AI session indicates completion, then transparently transmit the second message container in the SM context modification result of the AI session to the terminal device, then send a resource configuration update result of the AI session to the AMF device, and receive the update result confirmation message returned by the AMF device. Therefore, the AI session is updated through an AI session update process closely coupled with a network process, so that the communication system may provide the AI service systematically and reliably.

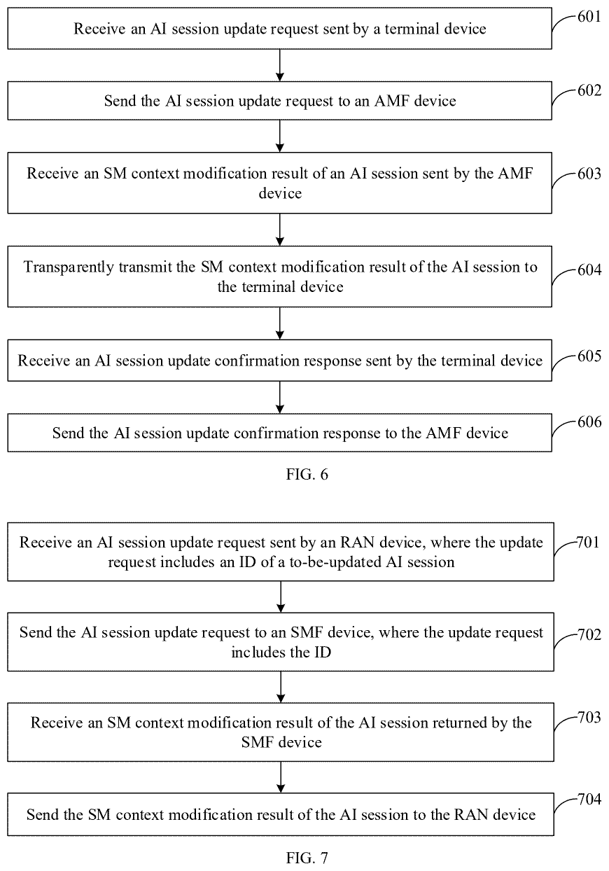

Referring to FIG. 6, FIG. 6 is a schematic flowchart of a method for updating an artificial intelligence session provided by an embodiment of the present disclosure. The method is executed by a radio access network (RAN) device. As shown in FIG. 6, the method may include but is not limited to the following steps 601-606.

At step 601, an artificial intelligence (AI) session update request sent by a terminal device is received.

At step 602, the AI session update request is sent to an access and mobility management function (AMF) device.

At step 603, a session management (SM) context modification result of an AI session sent by the AMF device is received.

At step 604, the SM context modification result of the AI session is transparently transmitted to the terminal device.

In the present disclosure, the specific implementation processes of the steps 601-604 may refer to detailed description of any embodiment of the present disclosure, which is not repeated herein.

At step 605, an update confirmation response for the AI session sent by the terminal device is received.

In the present disclosure, after the terminal device completes modification of the AI service parameters, the terminal device may send the update confirmation response for the AI session to the RAN device. Therefore, the RAN device may determine, according to the update confirmation response for the AI session, that the terminal device has completed the AI session invoking preparation, and then may instruct the AI network element device to configure the AI service to be available, so that the terminal device invokes the AI service, thereby improving reliability of a communication connection.

At step 606, the update confirmation response for the AI session is sent to the AMF device.

In the present disclosure, after the RAN device receives the update confirmation response for the AI session sent by the terminal device, the RAN device may send the update confirmation response for the AI session to the AMF device. Therefore, the AMF device may determine that the terminal device has completed the AI session invoking preparation.

Optionally, the RAN device may further encapsulate the update confirmation response for the AI session in an N2 NAS uplink transfer message, and send the N2 NAS uplink transfer message to the AMF device.

In the present disclosure, after the RAN device receives the AI session update request sent by the terminal device, the RAN device may send the AI session update request to the AMF device; then after the RAN device receives the SM context modification result of the AI session sent by the AMF device, the RAN device may transparently transmit the SM context modification result of the AI session to the terminal device; and then after the RAN device receives the update confirmation response for the AI session sent by the terminal device, the RAN device may send the update confirmation response for the AI session to the AMF device. Therefore, the AI session is updated and interacted through an AI session update process closely coupled with a network process, so that the communication system may provide the AI service systematically and reliably.

Referring to FIG. 7, FIG. 7 is a schematic flowchart of a method for updating an artificial intelligence session provided by an embodiment of the present disclosure. The method is executed by an access and mobility management function (AMF) device. As shown in FIG. 7, the method may include but is not limited to the following steps 701-704.

At step 701, an artificial intelligence (AI) session update request sent by a radio access network (RAN) device is received, where the update request includes an ID of a to-be-updated AI session.

The AI session update request may include an ID, a request type, AI attribute information, etc., which is not limited in the present disclosure.

In the present disclosure, the ID may be any information that may uniquely identify the AI session. For example, the ID may be an AI session serial number generated by the terminal device based on a type or an identifier of a to-be-updated AI service and an identifier of the terminal device, etc., which is not limited in the present disclosure.

The AI attribute information may include information, such as a name, a priority, a feature word, etc., of the requested AI service, that may uniquely identify an AI service, which is not limited in the present disclosure.

The request type may be any type of operations to the session, for example, modifying the session, creating the session, deleting the session, etc. It may be understood that the request type in the AI session update request is the modifying session.

In the present disclosure, after the RAN device receives the AI session update request sent by the terminal device, the RAN device may send the AI session update request to the AMF device to update the AI session.

At step 702, the AI session update request is sent to a session management function (SMF) device, where the update request includes the ID.

In the present disclosure, after the AMF device receives the AI session update request, the AMF device may determine a corresponding ID by parsing the AI session update request. Then the AMF device may compare the ID with IDs of established AI sessions, and when determining that the ID of the to-be-updated AI session matches any one of the IDs of the established AI sessions, determine that the AI session with the ID has been established, and then send the AI session update request to the SMF device.

Optionally, when determining that the ID of the to-be-updated AI session does not match any one of IDs of the established AI sessions, the AMF device may return an AI session update failure message to the RAN device, and end the AI session update process.

Optionally, the AMF device may invoke an Nsmf_AISession_UpdateSMContext request to update the AI session.

At step 703, a session management (SM) context modification result of the AI session returned by the SMF device is received.

The session management context modification result may include information, such as the ID, the AI attribute information, a state of the session management context modification result, etc., which is not limited in the present disclosure.

In the present disclosure, after the SMF device receives the AI session update request, the SMF device may determine the ID and the AI session attribute information by parsing the AI session update request, and then the SMF device may update the SM context for the AI session with ID according to the AI session attribute information, and generate the SM context modification result. Therefore, the other devices may determine, according to the SM context modification result, whether the AI session context update succeeds.

At step 704, the SM context modification result of the AI session is sent to the RAN device.

In the present disclosure, after the AMF device receives the SM context modification result, the AMF device may send the SM context modification result of the AI session to the RAN device. Therefore, the RAN device may determine, through the SM context modification result, whether the AI session update is completed.

In the present disclosure, after the AMF device receives the AI session update request, sent by the RAN device, including the ID of the to-be-updated AI session, the AMF device may send the AI session update request including the ID to the SMF device; and then, after the AMF device receives the SM context modification result of the AI session returned by the SMF device, the AMF device may send the SM context modification result of the AI session to the RAN device. Therefore, the AI session is updated through an AI session update process closely coupled with a network process, so that the communication system may provide the AI service systematically and reliably.

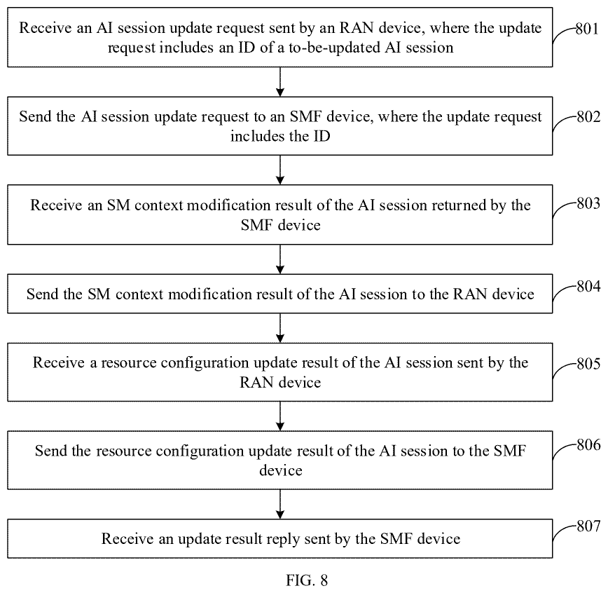

Referring to FIG. 8, FIG. 8 is a schematic flowchart of a method for updating an artificial intelligence session provided by an embodiment of the present disclosure. The method is executed by an access and mobility management function (AMF) device. As shown in FIG. 8, the method may include but is not limited to the following steps 801-807.

At step 801, an artificial intelligence (AI) session update request sent by a radio access network (RAN) device is received, where the update request includes an ID of a to-be-updated AI session.

At step 802, the AI session update request is sent to a session management function (SMF) device, where the update request includes the ID.

At step 803, an SM context modification result of the AI session returned by the SMF device is received.

At step 804, the SM context modification result of the AI session is sent to the RAN device.

In the present disclosure, the specific implementation processes of the steps 801-804 may refer to detailed description of any embodiment of the present disclosure, which is not repeated herein.

At step 805, a resource configuration update result of the AI session sent by the RAN device is received.

The resource configuration may be the quality of artificial intelligence (AI) service (QoAIS), the AI data flow, etc., which is not limited in the present disclosure.

In the present disclosure, when the RAN device determines that the SM context modification result of the AI session is in the success state, the RAN device may update the resource configuration for the AI session according to the AI attribute information in the SM context modification result, and generate a resource configuration update result of the AI session, to indicate whether the update of the resource configuration for the AI session succeeds.

In the present disclosure, after the RAN device completes the update of the resource configuration for the AI session, the RAN device may send the resource configuration update result of the AI session to the AMF device, to indicate that the RAN device has completed the update of the resource configuration for the AI session.

At step 806, the resource configuration update result of the AI session is sent to the SMF device.

In the present disclosure, after the AMF device receives the resource configuration update result of the AI session fed back by the RAN device, the AMF device may send the resource configuration update result of the AI session to the SMF device. Therefore, the SMF device may determine that the RAN device has completed the update of the resource configuration for the AI session.

At step 807, an update result reply sent by the SMF device is received.

In the present disclosure, after the SMF device receives the resource configuration update result of the AI session sent by the AMF device, the SMF device may return the update result reply to the AMF device, to indicate that the SMF device has received the resource configuration update result of the AI session. Therefore, confirmation and interaction of the resource configuration related information between the AMF device and the SMF device are completed through the AI session update process closely coupled with the network process.

In the present disclosure, after the AMF device receives the AI session update request, sent by the RAN device, including the ID of the to-be-updated AI session, the AMF device may send the AI session update request including the ID to the SMF device; then, after the AMF device receives the SM context modification result of the AI session returned by the SMF device, the AMF device may send the SM context modification result of the AI session to the RAN device; and then after the AMF receives the resource configuration update result of the AI session sent by the RAN device, the AMF device may send the resource configuration update result of the AI session to the SMF device, and then receive the update result reply sent by the SMF device. Therefore, the AI session is updated through an AI session update process closely coupled with a network process, so that the communication system may provide the AI service systematically and reliably.

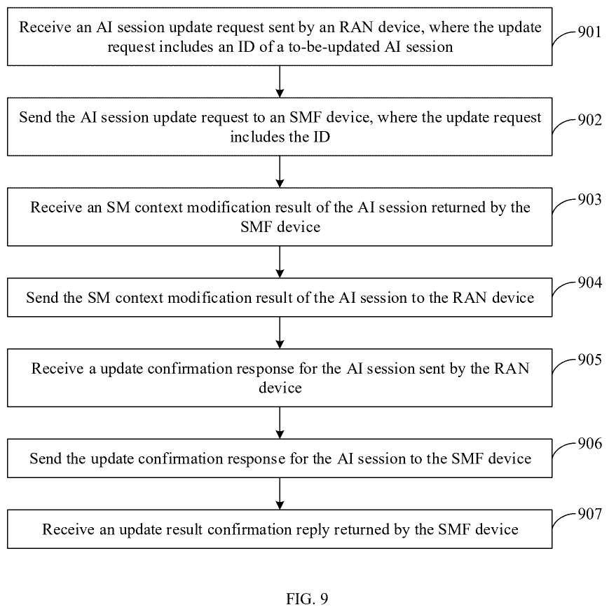

Referring to FIG. 9, FIG. 9 is a schematic flowchart of a method for updating an artificial intelligence session provided by an embodiment of the present disclosure. The method is executed by an access and mobility management function (AMF) device. As shown in FIG. 9, the method may include but is not limited to the following steps 901-907.

At step 901, an artificial intelligence (AI) session update request sent by a radio access network (RAN) device is received, where the update request includes an ID of a to-be-updated AI session.

At step 902, the AI session update request is sent to a session management function (SMF) device, where the update request includes the ID.

At step 903, an SM context modification result of the AI session returned by the SMF device is received.

At step 904, the SM context modification result of the AI session is sent to the RAN device.

In the present disclosure, the specific implementation processes of the steps 901-904 may refer to detailed description of any embodiment of the present disclosure, which is not repeated herein.

At step 905, an update confirmation response for the AI session sent by the RAN device is received.

In the present disclosure, after the RAN device receives the update confirmation response for the AI session sent by the terminal device, the RAN device may send the update confirmation response for the AI session to the AMF device. Therefore, the AMF device may determine, according to the update confirmation response for the AI session, that the terminal device has completed the AI session invoking preparation, and then may instruct the AI network element device to configure the AI service to be available, so that the terminal device invokes the AI service, thereby improving reliability of a communication connection.

At step 906, the update confirmation response for the AI session is sent to the SMF device.

In the present disclosure, after the AMF device receives the update confirmation response for the AI session, the AMF device may send the update confirmation response for the AI session to the SMF device. Therefore, the SMF device may determine that the terminal device has completed the AI session invoking preparation.

At step 907, an update result confirmation reply returned by the SMF device is received.

In the present disclosure, after the SMF device receives the update confirmation response for the AI session sent by the AMF device, the SMF device may return the update result confirmation reply to the AMF device, to indicate that the SMF device has received the update confirmation response for the AI session. Therefore, confirmation and interaction of the resource configuration related information between the AMF device and the RAN device are completed through an AI session update process closely coupled with the network process.

In the present disclosure, after the AMF device receives the AI session update request, sent by the RAN device, including the ID of the to-be-updated AI session, the AMF device may send the AI session update request including the ID to the SMF device; then, after the AMF device receives the SM context modification result of the AI session returned by the SMF device, the AMF device may send the SM context modification result of the AI session to the RAN device; and then after the AMF receives the update confirmation response for the AI session sent by the RAN device, the AMF device may send the update confirmation response for the AI session to the SMF device, and then receive the update result confirmation reply sent by the SMF device. Therefore, the AI session is updated through an AI session update process closely coupled with a network process, so that the communication system may provide the AI service systematically and reliably.

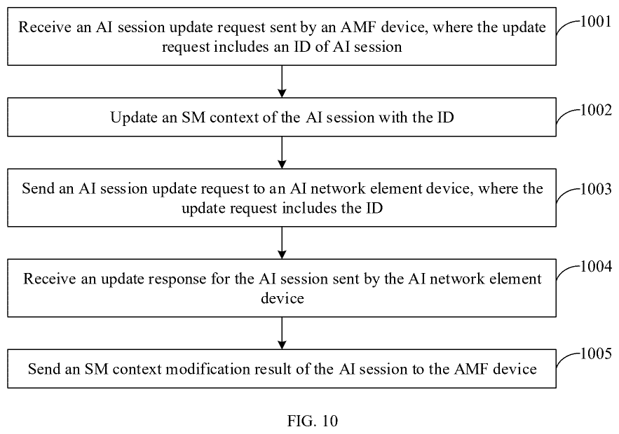

Referring to FIG. 10, FIG. 10 is a schematic flowchart of a method for updating an artificial intelligence session provided by an embodiment of the present disclosure. The method is executed by an SMF device. As shown in FIG. 10, the method may include but is not limited to the following steps 1001-1005.

At step 1001, an AI session update request sent by an AMF device is received, where the update request includes an ID.

The AI session update request may include an ID, a request type, AI attribute information, etc., which is not limited in the present disclosure.

In the present disclosure, the ID may be any information that may uniquely identify the AI session. For example, the ID may be an AI session serial number generated by the terminal device based on a type or an identifier of a to-be-updated AI service and an identifier of the terminal device, etc., which is not limited in the present disclosure.

The AI attribute information may include information, such as a name, a priority, a feature word, etc., of the requested AI service, that may uniquely identify an AI service, which is not limited in the present disclosure.

The request type may be any type of operations to the session, for example, modifying the session, creating the session, deleting the session, etc. It may be understood that the request type in the AI session update request is the modifying session.

In the present disclosure, after the AMF device receives the AI session update request, the AMF device may send the AI session update request to the SMF device to update the AI session.

At step 1002, a session management (SM) context for the AI session with the ID is updated.

The session management context modification result may include information, such as the ID, the AI attribute information, a state of the session management context modification result, etc., which is not limited in the present disclosure.

In the present disclosure, after the SMF device receives the AI session update request, the SMF device may determine the ID and the AI session attribute information by parsing the AI session update request, and then the SMF device may update the SM context for the AI session with ID according to the AI session attribute information, and generate the SM context modification result, to provide a condition for the terminal device to invoke the AI application.

Optionally, the SM context modification result may include two message containers, where a message container for instructing the SM context modification result to the RAN device may be a first message container for carrying a message transmitted by an N2 interface, and a message container for instructing the SM context modification result to the terminal device may be a second message container for carrying a message transmitted by an N1 interface. The N1 interface may be an interface for interacting messages between the RAN device and the terminal device, and the N2 interface may be an interface for interacting messages between the RAN device and the AMF device.

In addition, the N2 message and the N1 message may include an ID, AI attribute information, a state of a corresponding SM context modification result, etc., which is not limited in the present disclosure.

At step 1003, the AI session update request is sent to an AI network element device, where the update request includes the ID.

In the present disclosure, after the SMF device receives the AI session update request, the SMF device may send the AI session update request to the AI network element device, so that the AI network element device may determine that the terminal device has initiated the AI session update request.

Optionally, the SMF device may send the AI session update request to the AI network element device by an N4′ interface session modification request message. The N4′ interface may be an interface for interacting messages between the SMF device and the AI network element device.

At step 1004, an update response for the AI session sent by the AI network element device is received.

In the present disclosure, the AI network element device may determine the to-be-updated AI attribute information and the ID by parsing the AI session update request, and then may update the related attribute information in the AI session with the ID according to the to-be-updated AI attribute information. Then, the AI network element device may return an update response for the AI session to the SMF device, to indicate whether the AI session update succeeds. Therefore, the SMF device may determine, according to the update response for the AI session, whether the AI session update succeeds.

At step 1005, an SM context modification result of the AI session is sent to the AMF device.

In the present disclosure, after the SMF device determines that the AI session update succeeds, the SMF device may send the SM context modification result of the AI session to the AMF device. Therefore, the AMF device may determine, according to the SM context modification result, whether the AI session update succeeds.

In the present disclosure, after the SMF device receives the AI session update request, sent by the AMF device, including the ID, the SMF device may update the SM context for the AI session with the ID, then may send the AI session update request including the ID to the AI network element device, receive the update response for the AI session sent by the AI network element device, and then send the SM context modification result of the AI session to the AMF device. Therefore, the AI session is updated through an AI session update process closely coupled with a network process, so that the communication system may provide the AI service systematically and reliably.

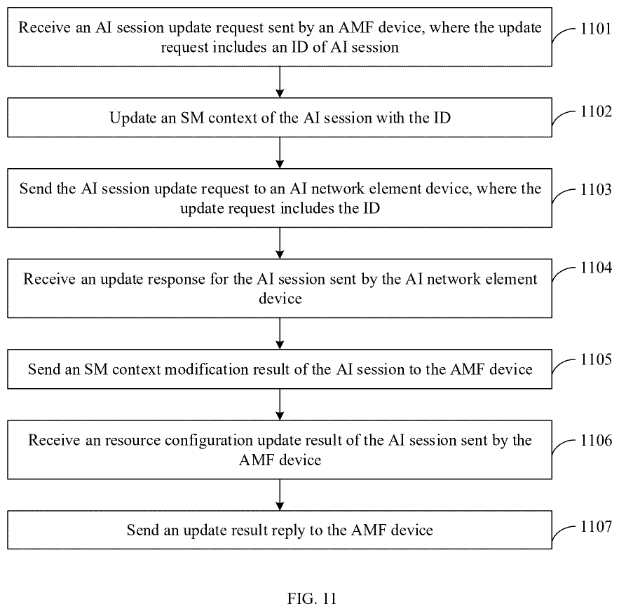

Referring to FIG. 11, FIG. 11 is a schematic flowchart of a method for updating an artificial intelligence session provided by an embodiment of the present disclosure. The method is executed by a session management function (SMF) device. As shown in FIG. 11, the method may include but is not limited to the following steps 1101-1107.

At step 1101, an artificial intelligence (AI) session update request sent by an access and mobility management function (AMF) device is received, where the update request includes an ID.

At step 1102, an SM context of the AI session with the ID is updated.

At step 1103, the AI session update request is sent to an AI network element device, where the update request includes the ID.

At step 1104, an update response for the AI session sent by the AI network element device is received.

At step 1105, an SM context modification result of the AI session is sent to the AMF device.

In the present disclosure, the specific implementation processes of the steps 1101-1105 may refer to detailed description of any embodiment of the present disclosure, which is not repeated herein.

At step 1106, a resource configuration update result of the AI session sent by the AMF device is received.

The resource configuration may be the quality of artificial intelligence (AI) service (QoAIS), the AI data flow, etc., which is not limited in the present disclosure.

In the present disclosure, after the AMF device receives the resource configuration update result of the AI session sent by the RAN device, the AMF device may send the resource configuration update result of the AI session to the SMF device. Therefore, the SMF device may determine that the RAN device has completed the update of the resource configuration for the AI session.

At step 1107, an update result reply is sent to the AMF device.

In the present disclosure, after the SMF device receives the resource configuration update result of the AI session, the SMF device may send the update result reply to the AMF device, to indicate that the SMF device has received the resource configuration update result of the AI session.

In the present disclosure, after the SMF device updates the SM context for the AI session with the ID according to the AI session update request, the SMF device may send the SM context modification result of the AI session to the AMF device, and then after the SMF device receives the resource configuration update result of the AI session sent by the AMF device, the SMF device may send the update result reply to the AMF device. Therefore, the AI session is updated through an AI session update process closely coupled with a network process, so that the communication system may provide the AI service systematically and reliably.

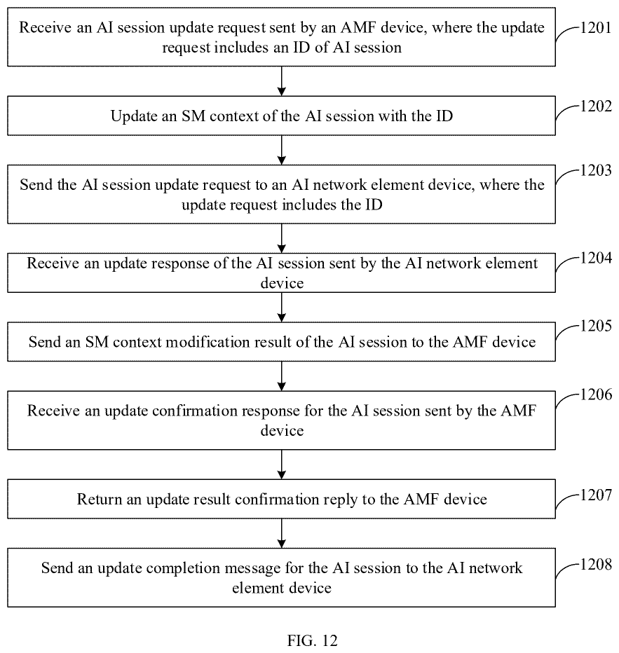

Referring to FIG. 12, FIG. 12 is a schematic flowchart of a method for updating an artificial intelligence session provided by an embodiment of the present disclosure. The method is executed by an SMF device. As shown in FIG. 12, the method may include but is not limited to the following steps 1201-1208.

At step 1201, an AI session update request sent by an AMF device is received, where the update request includes an ID.

At step 1202, as SM context for the AI session with the ID is updated.

At step 1203, the AI session update request is sent to an AI network element device, where the update request includes the ID.

At step 1204, an update response for the AI session sent by the AI network element device is received.

At step 1205, an SM context modification result of the AI session is sent to the AMF device.

In the present disclosure, the specific implementation processes of the steps 1201-1205 may refer to detailed description of any embodiment of the present disclosure, which is not repeated herein.

At step 1206, an update confirmation response for the AI session sent by the AMF device is received.

In the present disclosure, after the AMF device receives the update confirmation response for the AI session, the AMF device may send the update confirmation response for the AI session to the SMF device. Therefore, the SMF device may determine, according to the update confirmation response for the AI session, that the terminal device has completed the AI session invoking preparation, and then may instruct the AI network element device to configure the corresponding AI session to be available, so that the terminal device invokes the AI service, thereby improving reliability of a communication connection.

At step 1207, an update result confirmation reply is returned to the AMF device.

In the present disclosure, after the SMF device receives the update confirmation response for the AI session sent by the AMF device, the SMF device may return the update result confirmation reply to the AMF device, to indicate that the SMF device has received the update confirmation response for the AI session.

At step 1208, an update completion message for the AI session is sent to the AI network element device.

In the present disclosure, the SMF device may determine, according to the update confirmation response for the AI session, whether the AI session update confirmation succeeds. In the case where the AI session update confirmation succeeds, it indicates that the terminal device has completed the preparation for invoking the AI session, and in this case, the SMF device may send the update completion message for the AI session to the AI network element device.

Optionally, in the case where the AI session update confirmation fails, the SMF device may not send the AI session update confirmation completion message to the AI network element device, or may send an AI session update confirmation failure message to the AI network element device.

In the present disclosure, after the SMF device updates the SM context for the AI session with the ID according to the AI session update request, the SMF device may send the SM context modification result of the AI session to the AMF device, and then after the SMF device receives the update confirmation response for the AI session sent by the AMF device, the SMF device may return the update result confirmation reply to the AMF device, and send the update completion message for the AI session to the AI network element device. Therefore, the AI session is updated through an AI session update process closely coupled with a network process, so that the communication system may provide the AI service systematically and reliably.

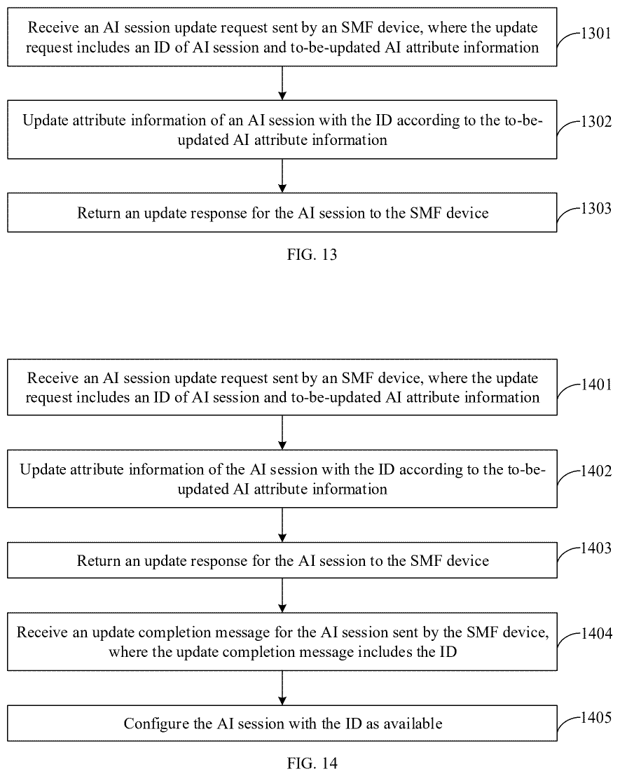

Referring to FIG. 13, FIG. 13 is a schematic flowchart of a method for updating an artificial intelligence session provided by an embodiment of the present disclosure. The method is executed by an AI network element device. As shown in FIG. 13, the method may include but is not limited to the following steps 1301-1303.

At step 1301, an AI session update request sent by an SMF device is received, where the update request includes an ID and to-be-updated AI attribute information.

The AI session update request may include an ID, a request type, AI attribute information, etc., which is not limited in the present disclosure.

In the present disclosure, the ID may be any information that may uniquely identify the AI session. For example, the ID may be an AI session serial number generated by the terminal device based on a type or an identifier of a to-be-updated AI service and an identifier of the terminal device, etc., which is not limited in the present disclosure.

The AI attribute information may include information, such as a name, a priority, a feature word, etc., of the requested AI service, that may uniquely identify an AI service, which is not limited in the present disclosure.

The request type may be any type of operations to the session, for example, modifying the session, creating the session, deleting the session, etc. It may be understood that the request type in the AI session update request is the modifying session.

In the present disclosure, after the SMF device receives the AI session update request, the SMF device may send the AI session update request to the AI network element device, so that the AI network element device may determine that the terminal device has initiated the AI session update request.

At step 1302, attribute information for the AI session with the ID is updated according to the to-be-updated AI attribute information.

In the present disclosure, the AI network element device may determine the to-be-updated AI attribute information and the ID by parsing the AI session update request, and then may update the attribute information for the AI session with the ID according to the to-be-updated AI attribute information.

At step 1303, an update response for the AI session is returned to the SMF device.

In the present disclosure, after the AI network element device completes the attribute information update for the AI session, the AI network element device may return the update response for the AI session to the SMF device, to indicate whether the AI session update succeeds.

In the present disclosure, after the AI network element device receives the AI session update request, sent by the SMF device, including the ID and the to-be-updated AI attribute information, the AI network element device may update the attribute information for the AI session with the ID according to the to-be-updated AI attribute information, and then may return the update response for the AI session to the SMF device. Therefore, the AI session is updated through an AI session update process closely coupled with a network process, so that the communication system may provide the AI service systematically and reliably.

Referring to FIG. 14, FIG. 14 is a schematic flowchart of a method for updating an artificial intelligence session provided by an embodiment of the present disclosure. The method is executed by an AI network element device. As shown in FIG. 14, the method may include but is not limited to the following steps 1401-1405.

At step 1401, an AI session update request sent by an SMF device is received, where the update request includes an ID and to-be-updated AI attribute information.

At step 1402, attribute information for the AI session with the ID is updated according to the to-be-updated AI attribute information.

At step 1403, an update response for the AI session is returned to the SMF device.

In the present disclosure, the specific implementation processes of the steps 1401-1403 may refer to detailed description of any embodiment of the present disclosure, which is not repeated herein.

At step 1404, an update completion message for the AI session sent by the SMF device is received, where the update completion message includes the ID.

In the present disclosure, the SMF device may determine, according to the update confirmation response for the AI session, whether the AI session update confirmation succeeds. In the case where the AI session update confirmation succeeds, it indicates that the terminal device has completed the preparation for invoking the AI session, and in this case, the SMF device may send the update completion message for the AI session to the AI network element device.

At step 1405, an AI session with the ID is configured to be available.

In the present disclosure, after the AI network element device receives the update completion message for the AI session, the AI network element device may determine that the terminal device has completed the AI session invoking preparation, and the AI network element device may configure the AI session with the ID to be available in this time, so that the terminal device may invoke the AI service.

In the present disclosure, after the AI network element device receives the AI session update request, sent by the SMF device, including the ID and the to-be-updated AI attribute information, the AI network element device may update the attribute information for the AI session with the ID according to the to-be-updated AI attribute information, and return the update response for the AI session to the SMF device; and then the AI network element device may receive the update completion message for the AI session, sent by the SMF device, including the ID, and configure the AI session with the ID to be available. Therefore, the AI session is updated through an AI session update process closely coupled with a network process, so that the communication system may provide the AI service systematically and reliably.

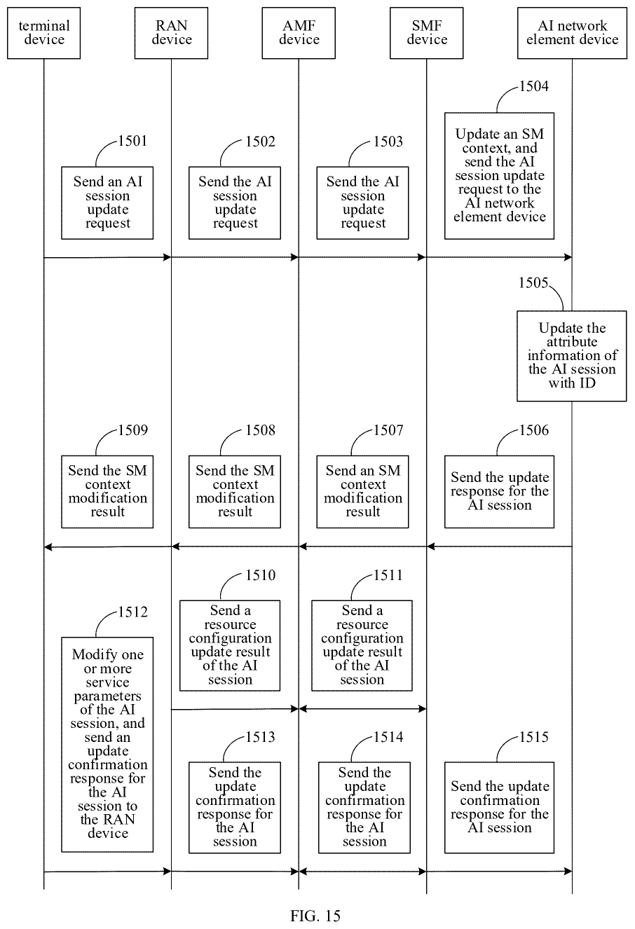

Referring to FIG. 15, FIG. 15 is a schematic interaction diagram of a method for updating an artificial intelligence session provided by an embodiment of the present disclosure. As shown in FIG. 15, the method may include but is not limited to the following steps 1501-1515.

At step 1501, a terminal device sends an artificial intelligence (AI) session update request to a radio access network (RAN) device.

At step 1502, the RAN device sends the AI session update request to an access and mobility management function (AMF) device.

At step 1503, the AMF device sends the AI session update request to a session management function (SMF) device, where the update request includes the ID.

At step 1504, the SMF device updates an SM context for the AI session with the ID, and sends the AI session update request to an AI network element device, where the update request includes the ID.

At step 1505, the AI network element device receives the AI session update request, sent by the SMF device, including the ID and the to-be-updated AI attribute information, and may update the attribute information for the AI session with the ID according to the to-be-updated AI attribute information.

At step 1506, the AI network element device returns the update response for the AI session to the SMF device.

At step 1507, the SMF device sends an SM context modification result of the AI session to the AMF device.

At step 1508, the AMF device sends the SM context modification result of the AI session to the RAN device.

At step 1509, the RAN device transparently transmits the SM context modification result of the AI session to the terminal device.

At step 1510, the RAN device updates the resource configuration for the AI session, and sends a resource configuration update result of the AI session to the AMF device.

At step 1511, the AMF device sends a resource configuration update result of the AI session to the SMF device, and receives an update result confirmation message returned by the SMF device.

At step 1512, in the case where the SM context modification result of the AI session indicates completion, the terminal device modifies one or more service parameters of the AI session, and sends an update confirmation response for the AI session to the RAN device.

At step 1513, the RAN device sends the update confirmation response for the AI session to the AMF device.

At step 1514, the AMF device sends the update confirmation response for the AI session to the SMF device, and receives an update result confirmation reply returned by the SMF device.

At step 1515, the SMF device sends the update confirmation response for the AI session to the AI network element device.

In the present disclosure, the specific implementation manners of the steps 1501-1515 may refer to detailed description of any embodiment of the present disclosure, which is not repeated herein.

In the present disclosure, the terminal device may send the AI session update request, and transmit the AI session update request to the AI network element device through network devices; after the AI network element device receives the AI session update request, the AI network element device may update the attribute information for the AI session with the ID according to the to-be-updated AI attribute information, and transmit the update response for the AI session to the terminal device through the network devices; after the terminal device receives the update response for the AI session, the terminal device may modify the service parameters of the AI session, and transmit the update confirmation response for the AI session to the AI network element device through the network devices; and the network devices may also update the AI session related resource configuration and the session context information. Therefore, the AI session is updated through an AI session update process closely coupled with a network process, so that the communication system may provide the AI service systematically and reliably.

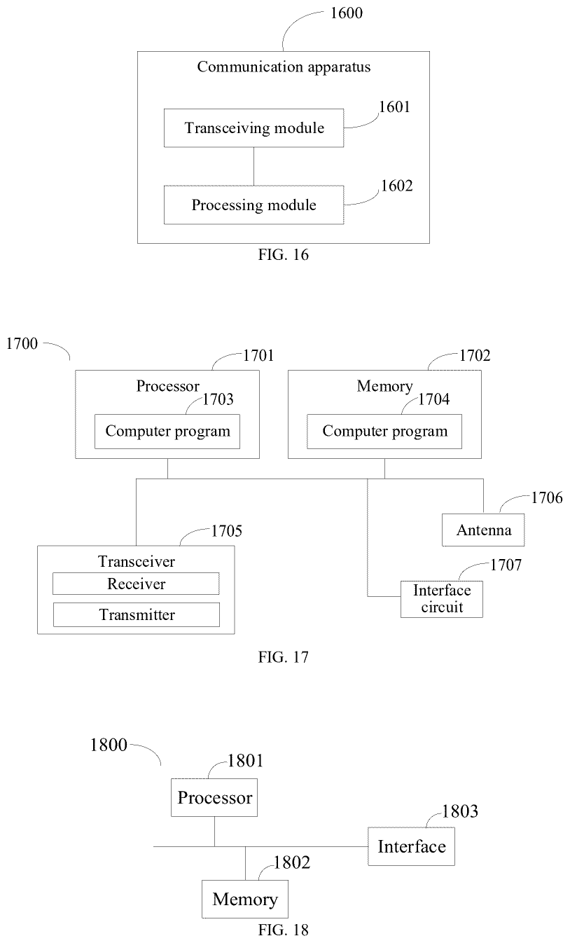

Referring to FIG. 16, FIG. 16 is a schematic structural diagram of a communication apparatus 1600 provided by an embodiment of the present disclosure. The communication apparatus 1600 shown in FIG. 16 may include a transceiving module 1601 and a processing module 1602. The transceiving module 1601 may include a transmitting module and/or a receiving module. The transmitting module is configured to implement a transmitting function, the receiving module is configured to implement a receiving function, and the transceiving module 1601 may implement the transmitting function and/or the receiving function.

It can be understood that the communication apparatus 1600 may be a terminal device, may be an apparatus in the terminal device, or may be an apparatus that can be used in cooperation with the terminal device.

The communication apparatus 1600 is on a terminal device side.

The transceiving module 1601 is configured to send an artificial intelligence (AI) session update request to a radio access network (RAN) device; and
the transceiving module 1601 is further configured to receive a session management (SM) context modification result of an AI session returned by the RAN device.

Optionally, the AI session update request includes at least one of: an ID, a request type, or AI attribute information.

Optionally, the communication apparatus further includes:
a processing module 1602, configured to modify, in a case where the SM context modification result of the AI session indicates completion, one or more service parameters of the AI session;
where the transceiving module 1601 is further configured to send an update confirmation response for the AI session to the RAN device.

Optionally, the transceiving module 1601 is configured to:
send, through a non-access stratum (NAS) message, the AI session update request to the RAN device.

It can be understood that the communication apparatus 1600 may be an RAN device, an apparatus in the RAN device, or an apparatus that can be used in cooperation with the RAN device.

The communication apparatus 1600 is on an RAN device side.

The transceiving module 1601 is configured to receive an artificial intelligence (AI) session update request sent by a terminal device;
the transceiving module 1601 is further configured to send the AI session update request to an access and mobility management function (AMF) device;
the transceiving module 1601 is further configured to receive a session management (SM) context modification result of an AI session sent by the AMF device; and
the transceiving module 1601 is further configured to transparently transmit the SM context modification result of the AI session to the terminal device.

Optionally, the communication apparatus further includes:
a processing module 1602, configured to update, in a case where the SM context modification result of the AI session indicates completion, a resource configuration for the AI session;
where the transceiving module 1601 is further configured to send a resource configuration update result of the AI session to the AMF device; and
the transceiving module 1601 is further configured to receive an update result confirmation message returned by the AMF device.

Optionally, the processing module 1602 is further configured to:
according to a first message container in the SM context modification result of the AI session, determine a state of the SM context modification result of the AI session.

Optionally, the transceiving module 1601 is configured to:
transparently transmit a second message container in the SM context modification result of the AI session to the terminal device.

Optionally, the transceiving module 1601 is further configured to:
receive an update confirmation response for the AI session sent by the terminal device; and
send the update confirmation response for the AI session to the AMF device.

It can be understood that the communication apparatus 1600 may be an AMF device, may be an apparatus in the AMF device, or may be an apparatus that can be used in cooperation with the AMF device.

The communication apparatus 1600 is on an AMF device side.

The transceiving module 1601 is configured to receive an AI session update request sent by an RAN device, where the update request includes an ID of a to-be-updated AI session;
where the transceiving module 1601 is further configured to send the AI session update request to an SMF device, where the update request includes the ID;
the transceiving module 1601 is further configured to receive session management (SM) context modification result of the AI session returned by the SMF device; and
the transceiving module 1601 is further configured to send the SM context modification result of the AI session to the RAN device.

Optionally, the transceiving module 1601 is further configured to:
return, when determining that the ID of the to-be-updated AI session does not match any one of IDs of established AI sessions, an AI session update failure message to the RAN device.

Optionally, the transceiving module 1601 is further configured to:
receive a resource configuration update result of the AI session sent by the RAN device;
send the resource configuration update result of the AI session to the SMF device; and
receive an update result reply sent by the SMF device.

Optionally, the transceiving module 1601 is further configured to:
receive an update confirmation response for the AI session sent by the RAN device;
send the update confirmation response for the AI session to the SMF device; and
receive an update result confirmation reply returned by the SMF device.

It can be understood that the communication apparatus 1600 may be an SMF device, may be an apparatus in the SMF device, or may be an apparatus that can be used in cooperation with the SMF device.

The communication apparatus 1600 is on an SMF device side.

The transceiving module 161 is configured to receive an AI session update request sent by an AMF device, where the update request includes an ID;
the processing module 1602 is configured to update an SM context of the AI session with the ID;
where the transceiving module 1601 is further configured to send the AI session update request to an AI network element device, where the update request includes the ID;
the transceiving module 1601 is further configured to receive an update response for the AI session sent by the AI network element device; and
the transceiving module 1601 is further configured to send an SM context modification result of the AI session to the AMF device.

Optionally, the transceiving module 1601 is further configured to:
receive a resource configuration update result for the AI session sent by the AMF device; and
send an update result reply to the AMF device.

Optionally, the transceiving module 1601 is further configured to:
send an update confirmation response for the AI session to the AMF device; and
return an update result confirmation reply to the AMF device.

Optionally, the transceiving module 1601 is further configured to:
send an update completion message for the AI session to the AI network element device.

It can be understood that the communication apparatus 1600 may be an AI network element device, an apparatus in the AI network element device, or an apparatus that can be used in cooperation with the AI network element device.

The communication apparatus 1600 is on an AI network element device side.

The transceiving module 1601 is configured to receive an AI session update request sent by a session management function (SMF) device, where the update request includes an ID and to-be-updated AI attribute information; and
the processing module 1602 is configured to update, according to the to-be-updated AI attribute information, attribute information of the AI session with the ID;
where the transceiving module 1601 is further configured to return an update response for the AI session to the SMF device.

Optionally, the transceiving module 1601 is further configured to:
receive an update completion message for the AI session sent by the SMF device, where the update completion message includes the ID; and
where the processing module 1602 is further configured to configuring an AI session with the ID to be available.

In the present disclosure, the terminal device may send the AI session update request to the RAN device, and then may receive the SM context modification result of the AI session returned by the RAN device. Therefore, the AI session is updated through an AI session update process closely coupled with a network process, so that the communication system may provide the AI service systematically and reliably.

Referring to FIG. 17, FIG. 17 is a schematic structural diagram of another communication apparatus 1700 provided by an embodiment of the present disclosure. The communication apparatus 1700 may be a network device or a terminal device; the communication apparatus 1700 may also be a chip, a chip system, or a processor that supports the network device to implement the above methods, etc.; the communication apparatus 1700 may also be a chip, a chip system, or a processor that supports the terminal device to implement the above methods. The apparatus may be configured to implement the methods described in the above method embodiments, which may specifically refer to the description in the above method embodiments.

The communication apparatus 1700 may include one or more processors 1701. The processors 1701 may be general-purpose processors, special-purpose processors, etc. For example, the processors may be baseband processors or central processing units. The baseband processor may be configured to process a communication protocol and communication data, and the central processing unit may be configured to control the communication apparatus (for example, a base station, a baseband chip, a terminal device, a terminal device chip, a DU, a CU, etc.), execute a computer program, and process data of the computer program.

Optionally, the communication apparatus 1700 may further include one or more memories 1702 that may store a computer program 1704. The processors 1701 execute the computer program 1704 to cause the communication apparatus 1700 to execute the methods described in the above method embodiments. Optionally, the memories 1702 may further store data. The communication apparatus 1700 and the memories 1702 may be separately configured, or may be integrated together.

Optionally, the communication apparatus 1700 may further include a transceiver 1705 and an antenna 1706. The transceiver 1705 may be referred to as a transceiving unit, a transceiving machine, a transceiving circuit, etc., and is configured to implement a transceiving function. The transceiver 1705 may include a receiver and a transmitter. The receiver may be referred to as a receiving machine, a receiving circuit, etc., and is configured to implement a receiving function. The transmitter may be referred to as a transmitting machine, a transmitting circuit, etc., and is configured to implement a transmitting function.

Optionally, the communication apparatus 1700 may further include one or more interface circuits 1707. The interface circuits 1707 are configured to receive code instructions and transmitting the code instructions to the processors 1701. The processors 1701 execute the code instructions to cause the communication apparatus 1700 to execute the methods described in the above method embodiments.

The communication apparatus 1700 is a terminal device, and the transceiver 1705 is configured to execute step 201 and step 202 in FIG. 2, step 301 and step 302 in FIG. 3, etc.

The communication apparatus 1700 is an RAN device, and the transceiver 1705 is configured to execute step 401, step 402, step 403, and step 404 in FIG. 4, step 506 and step 507 in FIG. 5, step 605 and step 606 in FIG. 6.

The communication apparatus 1700 is an AMF device, and the processors 1701 are configured to execute step 701 and step 702 in FIG. 7, etc.

The communication apparatus 1700 is an SMF device, and the transceiver 1705 is configured to execute step 1002 in FIG. 10, etc.

The communication apparatus 1700 is an AI network element device, and the processors 1701 are configured to execute step 1302 in FIG. 13, etc.

In an implementation, the processors 1701 may include a transceiver for implementing the receiving and transmitting functions. For example, the transceiver may be a transceiving circuit, an interface, or an interface circuit. The transceiving circuit, the interface, or the interface circuit for implementing the receiving and transmitting functions may be separate or integrated together. The transceiving circuit, the interface, or the interface circuit may be used to read and write codes/data, or the transceiving circuit, the interface, or the interface circuit may be used to transmit or transfer a signal.

In an implementation, the processors 1701 may store a computer program 1703, and the computer program 1703 is executed by the processors 1701, so that the communication apparatus 1700 may execute the methods described in the above method embodiments. The computer program 1703 may be fixed in the processors 1701, and in this situation, the processors 1701 may be implemented by hardware.

In an implementation, the communication apparatus 1700 may include a circuit, and the circuit may implement transmitting, receiving, or communicating functions in the above method embodiments. The processor and transceiver described in the present disclosure may be implemented on integrated circuits (ICs), analog ICs, radio frequency integrated circuits (RFICs), mixed signal ICs, application specific integrated circuits (ASICs), printed circuit boards (PCBs), electronic devices, etc. The processor and transceiver may also be fabricated with various IC process technologies, such as a complementary metal oxide semiconductor (CMOS), an n-metal oxide semiconductor (NMOS), a p-metal oxide semiconductor (positive channel metal oxide semiconductor, PMOS), a bipolar junction transistor (BJT), a bipolar CMOS (BiCMOS), a silicon germanium (SiGe), a gallium arsenide (GaAs), etc.

The communication apparatus described in the above embodiments may be a network device or an access network device (for example, the terminal device in the above method embodiments), but a scope of the communication apparatus described in the present disclosure is not limited thereto, and a structure of the communication apparatus may not be limited by FIG. 17.

The communication apparatus may be a separate device or may be a part of a larger device. For example, the communication apparatus may be:
(1) a separate integrated circuit IC, chip, or chip system or subsystem;
(2) a set of one or more ICs; optionally, the set of ICs may also include a storage component for storing data and a computer program;
(3) an ASIC, for example, a modem;
(4) a module that may be embedded within other devices;
(5) a receiving machine, a terminal device, an intelligent terminal device, a cellular phone, a wireless device, a handset, a mobile unit, an in-vehicle device, a network device, a cloud device, an artificial intelligence device, etc.; or
(6) other apparatus, etc.

The case in which the communication apparatus may be a chip or a chip system may refer to the schematic structural diagram of the chip shown in FIG. 18. The chip shown in FIG. 11 includes a processor 1801 and an interface 1803. There may be one or more processors 1801, and there may be multiple interfaces 1803.

For the case in which the chip is configured to implement functions of the terminal device in the embodiments of the present disclosure,
the interface 1803 is configured to execute step 201 and step 202 in FIG. 2, step 301 and step 302 in FIG. 3, etc.

For the case in which the chip is configured to implement functions of the RAN device in the embodiments of the present disclosure,
the interface 1803 is configured to execute step 401, step 402, step 403, and step 404 in FIG. 4, step 506 and step 507 in FIG. 5, step 605 and step 606 in FIG. 6, etc.

For the case in which the chip is configured to implement functions of the AMF device in the embodiments of the present disclosure,
the interface 1803 is configured to execute step 701 and step 702 in FIG. 7, etc.

For the case in which the chip is configured to implementing functions of the SMF device in the embodiments of the present disclosure,
the interface 1803 is configured to execute step 1001, step 1003, step 1004, and step 1005 in FIG. 10, etc.

For the case in which the chip is configured to implement functions of the AI network element device in the embodiments of the present disclosure,
the interface 1803 is configured to execute step 1301 and step 1303 in FIG. 13, etc.

Optionally, the chip further includes a memory 1802, and the memory 1802 is configured to store a necessary computer program and data.

Those skilled in the art may also understand that various illustrative logical blocks and steps listed in the embodiments of the present disclosure may be implemented by using electronic hardware, computer software, or a combination of the two. Whether such function is implemented by hardware or software depends on specific applications and design requirements of an overall system. Those skilled in the art may use various methods to implement the functions for each specific application, but this implementation should not be understood as going beyond the protection scope of the embodiments of the present disclosure.

The present disclosure further provides a readable storage medium storing instructions. When the instructions are executed by a computer, functions of any one of the above method embodiments are implemented.

The present disclosure further provides a computer program product. When the computer program product is executed by a computer, the functions of any one of the above method embodiments are implemented.

In the above embodiments, it may be implemented in whole or in part by software, hardware, firmware, or any combination thereof. When implemented in software, it may be implemented in whole or in part in the form of a computer program product. The computer program product includes one or more computer programs. When the computer programs are loaded and executed by a computer, the processes or functions according to embodiments of the present disclosure are generated in whole or in part. The computer may be a general purpose computer, a special purpose computer, a computer network, or other programmable apparatus. The computer programs may be stored in a computer readable storage medium or transmitted from one computer readable storage medium to another computer readable storage medium. For example, the computer programs may be transmitted from a website site, computer, server or data center to another website site, computer, server or data center by a wired (for example, a coaxial-cable, a fiber, a digital subscriber line (DSL)) or wirelessly (for example, infrared, wireless, microwave, etc.) manner. The computer readable storage medium may be any available medium that can be accessed by a computer or may be a data storage device, such as a server, data center, or the like, including one or more integrated available mediums. The available medium may be a magnetic medium (for example, a floppy disk, a hard disk, a magnetic tape), an optical medium (for example, a digital video disc (DVD)), or a semiconductor medium (for example, a solid state disk (SSD)), etc.

It can be understood that in the present disclosure, “multiple” refers to two or more, other quantifiers are similar thereto. “And/or” describes an association relationship of association objects, and represents that there may be three types of relationships. For example A and/or B may represent: existence of A alone, existence of both A and B, and existence of B alone. The character “/” generally represents that a relationship between the context association objects is an “or” relationship. The singular forms of “a/an,” “said,” and “the” are also intended to include the plural form, unless the context clearly indicates other meanings.

It can be further understood that in the embodiments of the present embodiment, although the operations are described in a specific order in the accompanying drawings, it should not be understood as requiring to execute these operations in a specific order or serial order as shown, or requiring to execute all shown operations to obtain the desired result. In specific environments, multitasking and parallel processing may be advantageous.

Those skilled in the art may understand that various numerical numbers such as “first” and “second” involved in the present disclosure are only for distinguishing for the convenience of description and are not intended to limit the scope of the embodiments of the present disclosure, and do not also represent an early-later sequence.

“At least one” in the present disclosure may also be described as one or more, and “a plurality of/multiple” may be two, three, four or more, which is not limited in the present disclosure. In the embodiments of the present disclosure, for a kind of technical features, technical features in the kind of technical features are distinguished by “first,” “second,” “third,” “A,” “B,” “C,” and “D,” etc., and there is no an early-later sequence or a large-small sequence among the technical features described by “first,” “second,” “third,” “A,” “B,” “C,” and “D”.

The correspondence relationships shown in each table in the present disclosure may be configured or predefined. Values of the information in each table are merely examples, and may be configured as other values, which is not limited in the present disclosure. When configuring correspondence relationships between the information and each parameter, it is not necessarily required to configure all the correspondence relationships shown in each table. For example, correspondence relationships shown in certain rows may also not be configured in the tables in the present disclosure. For another example, appropriate deformation adjustment may be executed based on the above tables, for example, splitting, merging, etc. A name of a parameter shown by a title in each of the above tables may also be another name that may be understood by the communication apparatus, and a value or a representation manner of the parameter may also be another value or representation manner that may be understood by the communication apparatus. During implementation of each of the above tables, other data structures may also be used, for example, an array, a queue, a container, a stack, a linear table, a pointer, a linked list, a tree, a graph, a structure body, a class, a heap, a hashing table of a hash table, etc., may be used.

Predefinition in the present disclosure may be understood as defining, pre-defining, storing, pre-storing, pre-negotiating, pre-configuring, curing, or pre-firing.

Those skilled in the art may realize that the units and algorithm steps of each example described in connection with the embodiments disclosed herein can be implemented in electronic hardware, or a combination of computer software and electronic hardware. Whether these functions are executed in hardware or software depends on the specific application and the design constraint condition of the technical solutions. Professional technicians may use different methods to implement the described functions for each specific application, but such implementation should not be considered to be beyond the scope of the present disclosure.

Those skilled in the art may clearly understand that for the convenience and conciseness of the description, the specific working processes of the systems, apparatuses, and units described above may refer to the corresponding processes in the aforementioned method embodiments, and will not be repeated here.

Those skilled in the art will easily come up with other implementation solutions of the present disclosure after considering the specification and practicing the present disclosure disclosed herein. The present disclosure aims to cover any variations, uses, or adaptive changes of the present disclosure, which follow general principles of the present disclosure and include common knowledge or customary technical means in the art not disclosed in the present disclosure. The specification and embodiments are only considered exemplary, and the true scope and spirit of the present disclosure are indicated by the following claims.

The above description is only specific implement manner of the present disclosure, and the protection scope of the present disclosure is not limited thereto. Any alteration or substitution that can be easily conceived by any those skilled in the art within the technical scope disclosed by the present disclosure shall fall within the protection scope of the present disclosure. Therefore, the protection scope of the present disclosure shall be subject to the protection scope of the claims.

According to a sixth aspect, an embodiment of the present disclosure provides another method for updating an artificial intelligence session. The method is executed by a session management function (SMF) device and includes: receiving an artificial intelligence (AI) session update request sent by an access and mobility management function (AMF) device, where the update request includes an identifier (ID); updating a session management (SM) context for the AI session with the ID; sending the AI session update request to an AI network element device, where the update request includes the ID; receiving an update response for the AI session sent by the AI network element device; and sending an SM context modification result of the AI session to the AMF device.

In the present disclosure, after the SMF device receives the AI session update request, sent by the AMF device, including the ID, the SMF device may update the SM context for the AI session with the ID, then may send the AI session update request including the ID to the AI network element device, receive the update response for the AI session sent by the AI network element device, and then send the SM context modification result of the AI session to the AMF device. Therefore, the AI session is updated through an AI session update process closely coupled with a network process, so that the communication system may provide the AI service systematically and reliably.

According to a seventh aspect, an embodiment of the present disclosure provides another method for updating an artificial intelligence session. The method is executed by an artificial intelligence (AI) network element device and includes: receiving an AI session update request sent by a session management function (SMF) device, where the update request includes an identifier (ID) and to-be-updated AI attribute information; updating, according to the to-be-updated AI attribute information, attribute information for the AI session with the ID; and returning an update response for the AI session to the SMF device.

In the present disclosure, after the AI network element device receives the AI session update request, sent by the SMF device, including the ID and the to-be-updated AI attribute information, the AI network element device may update the attribute information for the AI session with the ID according to the to-be-updated AI attribute information, and then may return the update response for the AI session to the SMF device. Therefore, the AI session is updated through an AI session update process closely coupled with a network process, so that the communication system may provide the AI service systematically and reliably.

According to an eighth aspect, an embodiment of the present disclosure provides a communication apparatus. The apparatus is on a terminal device side and includes:
a transceiving module, configured to send an artificial intelligence (AI) session update request to a radio access network (RAN) device;
where the transceiving module is further configured to receive a session management (SM) context modification result of an AI session returned by the RAN device.

According to a ninth aspect, an embodiment of the present disclosure provides a communication apparatus. The apparatus is on a radio access network (RAN) device side and includes:
a transceiving module, configured to receive an artificial intelligence (AI) session update request sent by a terminal device;
where the transceiving module is further configured to send the AI session update request to an access and mobility management function (AMF) device;
the transceiving module is further configured to receive a session management (SM) context modification result of an AI session sent by the AMF device; and
the transceiving module is further configured to transparently transmit the SM context modification result of the AI session to the terminal device.

According to an tenth aspect, an embodiment of the present disclosure provides a communication apparatus. The apparatus is on an access and mobility management function (AMF) device side and includes:
a transceiving module, configured to receive an artificial intelligence (AI) session update request sent by a radio access network (RAN) device, where the update request includes an identifier (ID) of a to-be-updated AI session;
where the transceiving module is further configured to send the AI session update request to a session management function (SMF) device, where the update request includes the ID;
the transceiving module is further configured to receive session management (SM) context modification result of the AI session returned by the SMF device; and
the transceiving module is further configured to send the SM context modification result of the AI session to the RAN device.

According to an eleventh aspect, an embodiment of the present disclosure provides a communication apparatus. The apparatus is on a session management function (SMF) device side and includes:
a transceiving module, configured to receive an artificial intelligence (AI) session update request sent by an access and mobility management function (AMF) device, where the update request includes an identifier (ID) of an AI session;
a processing module, configured to update a session management (SM) context for the AI session with the ID;
where the transceiving module is further configured to send the AI session update request to an AI network element device, where the update request includes the ID;
the transceiving module is further configured to receive an update response for the AI session sent by the AI network element device; and
the transceiving module is further configured to send an SM context modification result of the AI session to the AMF device.

According to a twelfth aspect, an embodiment of the present disclosure provides a communication apparatus. The apparatus is on an artificial intelligence (AI) network element device side and includes:
a transceiving module, configured to receive an AI session update request sent by a session management function (SMF) device, where the update request includes an identifier (ID) and to-be-updated AI attribute information; and
a processing module, configured to update, according to the to-be-updated AI attribute information, attribute information for the AI session with the ID;
where the transceiving module is further configured to return an update response for the AI session to the SMF device.

According to a thirteenth aspect, an embodiment of the present disclosure provides a system for creating an artificial intelligence session. The system includes the communication apparatus according to the fifth aspect, the communication apparatus according to the eighth aspect, the communication apparatus according to the ninth aspect, the communication apparatus according to the tenth aspect, the communication apparatus according to the eleventh aspect, the communication apparatus according to the twelfth aspect.

1. A method for updating an artificial intelligence (AI) session, the method comprising:
sending an AI session update request to a radio access network (RAN) device; and
receiving a session management (SM) context modification result of an AI session returned by the RAN device.

2. The method of claim 1, wherein the AI session update request comprises at least one of: an identifier (ID) of AI session, a request type, or AI attribute information.

3. The method of claim 1, further comprising:
in a case where the SM context modification result of the AI session indicates completion, modifying one or more service parameters of the AI session; and
sending an update confirmation response for the AI session to the RAN device.

4. The method of claim 1, wherein the sending the AI session update request to the RAN device, comprises:
sending, through a non-access stratum (NAS) message, the AI session update request to the RAN device.

5. A method for updating an artificial intelligence (AI) session, the method comprising:
receiving an AI session update request sent by a terminal device;
sending the AI session update request to an access and mobility management function (AMF) device;
receiving a session management (SM) context modification result of an AI session sent by the AMF device; and
transparently transmitting the SM context modification result of the AI session to the terminal device.

6. The method of claim 5, further comprising:
in a case where the SM context modification result of the AI session indicates completion, updating a resource configuration for the AI session;
sending a resource configuration update result of the AI session to the AMF device; and
receiving an update result confirmation message returned by the AMF device.

7. The method of claim 6, further comprising:
determining, according to a first message container in the SM context modification result of the AI session, a state of the SM context modification result of the AI session.

8. The method of claim 5, wherein the transparently transmitting the SM context modification result of the AI session to the terminal device, comprises:
transparently transmitting a second message container in the SM context modification result of the AI session to the terminal device.

9. The method of claim 6, further comprising:
receiving an update confirmation response for the AI session sent by the terminal device; and
sending the update confirmation response for the AI session to the AMF device.

10. A method for updating an artificial intelligence (AI) session, the method comprising:
receiving an AI session update request sent by a radio access network (RAN) device, wherein the update request comprises an identifier (ID) of a to-be-updated AI session;
sending the AI session update request to a session management function (SMF) device;
receiving a session management (SM) context modification result of the AI session returned by the SMF device; and
sending the SM context modification result of the AI session to the RAN device.

11. The method of claim 10, further comprising:
returning, when determining that the ID of the to-be-updated AI session does not match any one of IDs of established AI sessions, an AI session update failure message to the RAN device.

12. The method of claim 10, further comprising:
receiving a resource configuration update result of the AI session sent by the RAN device;
sending the resource configuration update result of the AI session to the SMF device; and
receiving an update result reply sent by the SMF device.

13. The method of claim 12, further comprising:
receiving an update confirmation response for the AI session sent by the RAN device;
sending the update confirmation response for the AI session to the SMF device; and
receiving an update result confirmation reply returned by the SMF device.

14-38. (canceled)

39. A communication apparatus, comprising:
one or more processors; and
a memory, wherein the memory stores a computer program, and
wherein the computer program when executed by the one or more processors causes the one or more processors to collectively perform the method of claim 1.

40. A non-transitory computer-readable storage medium; storing instructions, the instructions when executed by a processor of a terminal device cause the terminal device to perform the method of claim 1.

41. The method of claim 10, wherein the method is implemented by an access and mobility management function (AMF) device and the AMF device receives the SM context modification result of the AI session by:
after the AMF device sends the AI session update request to the SMF device, updating, by the SMF device, an SM context for the AI session with the ID, sending the AI session update request to an AI network element device, receiving an update response for the AI session sent by the AI network element device, and sending the SM context modification result of the AI session to the AMF device.

42. The method of claim 41, wherein the update request further comprises to-be-updated AI attribute information;
wherein after the SMF device sends the AI session update request to the AI network element device, the AI network element device updates, according to the to-be-updated AI attribute information, attribute information for the AI session with the ID, and returns the update response for the AI session to the SMF device.

43. The method of claim 42, wherein the SMF device is further configured to send an update completion message for the AI session to the AI network element device; and
the AI network element device is further configured to receive the update completion message for the AI session sent by the SMF device, and configure the AI session with the ID to be available.

44. A communication apparatus, comprising:
one or more processors; and
a memory that stores a computer program, and
wherein the computer program when executed by the one or more processors causes the one or more processors to perform the method of claim 5.

45. A non-transitory computer-readable storage medium storing instructions, the instructions when executed by a processor of a radio access network (RAN) device cause the RAN device to perform the method of claim 5.
